(19) United States
(12) Patent Application Publication
(10) Pub. No.: US 2026/0317081 A1
(43) Pub. Date: Oct. 15, 2026

(54) CONVEYING SYSTEM WITH STEERABLE WHEEL MOVERS AND METHOD OF OPERATING

(71) Applicant: SAIA-BURGESS LLC, VANDALIA, OH (US)

(72) Inventor: Adam W. STIENECKER, Tipp City, OH (US)

(21) Appl. No.: 19/693,057

(22) Filed: May 29, 2026

Related U.S. Application Data
(63) Continuation of application No. PCT/US2025/010712, filed on Jan. 8, 2025.

(51) Int. Cl. B65G 47/54

(52) U.S. Cl. CPC B65G 47/54

(57) ABSTRACT

A method of operating a conveying system having steerable wheel movers mechanically independent with one another can include directing a command from a master controller to at least a first sub-controller indicating a first sub-group of the steerable wheel movers and a first steer angle, which the first sub-controller applies to control at least one steerable wheel mover to move to the first steer angle to move a package. The method can also include determining, with the master controller, a second sub-group of the steerable wheel movers different than the first sub-group and directing a second command, indicating the second sub-group and a second steer angle, to the first sub-controller, which the first sub-controller applies to control at least one steerable wheel mover to move to the second steer angle.

### CROSS REFERENCE TO RELATED APPLICATIONS

This non-provisional patent application is a continuation application of PCT Application No. PCT/US2025/010712, filed with the USPTO on Jan. 8, 2025, which is incorporated herein by reference in its entirety.

### FIELD OF THE INVENTION

The present disclosure relates to power-driven conveyors for moving a load over a predetermined path or path section and configured to vary the operating modes of different portions of the one conveyor.

### BACKGROUND

U.S. Pat. No. 7,040,478 discloses a STEERABLE DIVERTER SYSTEM. The diverter system is for diverting articles being conveyed along the diverter system includes a plurality of diverter wheels arranged between opposite sidewalls of the diverter system. The diverter wheels are rotatably driven by a motorized roller and a plurality of drive members or bands reeved around the motorized roller and respective ones of the diverter wheels. The diverter wheels are steerable in response to pivotal or rotational movement of a drive gear that engages a gear plate of at least one of the wheels. The resulting pivotal movement of the at least one wheel causes a translational movement of a rack member extending along the row of diverter wheels which, in turn, causes a corresponding pivotal movement of the other wheels engaged with the rack member.

U.S. Pat. No. 9,505,560 discloses a SYSTEM AND METHOD FOR CONTROLLING A MOVING ELEMENT IN A LINEAR MOTOR CONVEYOR. The system for controlling moving elements includes a zone controller; a first network and a second network; at least one first motor gateway associated with a portion of the conveyor and assigned to the first network; and at least one second motor gateway associated with a different portion of the conveyor and assigned to the second network; wherein the zone controller and the motor gateways are configured to: communicate data to control the moving elements via the first and second networks in a structured manner to compensate for network or processing timing. A method for controlling moving elements including: communicating data related to control of the moving element conveyor, in a structured manner to compensate for network or processing timing, between a zone controller and first and second motor gateways.

U.S. Pat. No. 9,745,143 discloses a PITCH INDEPENDENT DIVERT DRIVE. The diverting conveyor has an array of transmissions having powered output rollers that form a conveying surface for selectively diverting articles from a first direction to a second direction. Each transmission has a timing belt pulley to operably engage with a toothed timing belt, and each is configured to simultaneously rotate the output roller from the first direction to the second direction in response to actuation of an actuator. When the timing belt pulley engages with the teeth of the timing belt, the output roller of an actuator is rotated around an axis perpendicular to the conveying surface to a rotational position that is a multiple of the tooth spacing of the timing belt. Each output roller has a driven direction resulting from the engagement of the timing belt with the timing belt pulley. An adjuster is provided to align the driven directions of the array of output rollers.

U.S. Pat. No. 10,810,534 discloses SYSTEMS AND METHODS FOR SORTATION OF PRODUCTS USING A CONVEYOR ASSEMBLY. In some embodiments, apparatuses and methods are provided useful to the sortation of products using a conveyor assembly. In some embodiments, there is provided a system for receiving and sorting products shipped to a shopping facility including: a delivery location at a shopping facility configured to receive a shipment of products; a conveyor assembly comprising: a product identification module configured to read identification data from an identification label disposed on a product; a plurality of sortation modules configured to move the product to one of a predetermined plurality of sortation destination areas; a control circuit operatively coupled to the product identification module and to each of the sortation modules, the control circuit configured to: receive the identification data from the product identification module; determine the sortation destination area for the product based at least on one of shopping facility data and shipping data regarding the product as sortation criteria; and cooperate with the plurality of sortation modules to move the product to the determined sortation destination area.

U.S. Pat. No. 11,358,803 discloses a CONTROL UNIT FOR A CONVEYOR WITH HARDWARE DETECTION. A method for configuring a control unit in a conveyor, wherein a control unit controls one or more conveyor segments comprising a conveyor drive in signal communication with the control unit via a motor connection socket, and a sensor for detecting an object at a position within the conveyor segment. The conveyor is in signal communication with the control unit via a sensor connection socket. The control unit self-configures itself by: (i) activating a configuration mode in the control unit, (ii) receiving a signal from each motor connection socket or sensor connection socket, (iii) comparing the received signal(s) with a comparative value stored in the control unit, and (iv) determining whether a conveyor drive or a sensor is connected to a motor connection socket or a sensor connection socket of the control unit, respectively, based on the comparison of the signal(s) with the comparative value.

U.S. Pat. No. 11,599,101 discloses an INDEPENDENT MOVER TRANSPORT SYSTEM AND METHOD OF EXTENDING RANGE OF OPERATIONS IN AN INDEPENDENT MOVER TRANSPORT SYSTEM. The system comprises a mover having an axis, and a track. The track includes first and second track segments, and a controller operative to drive a first coil of the first track segment to control movement of the mover along the first track segment towards the second track segment. The controller is further operative to define a first zone for the first track segment, define a second zone for the first track segment, drive the first coil to control movement of the mover with the first set of controller gain values when the location of the axis is in the first zone, and drive the first coil to control movement of the mover with second set of controller gain values when the location of the axis is in the second zone.

U.S. Pub. No. 2009/0084657 discloses a MODULAR WIRELESS CONVEYOR INTERCONNECTION METHOD AND SYSTEM. The modular conveyor system is disclosed in which components of each conveyor module is designed for wireless mesh communication. The communications may be within a module or between modules. Certain of the components may be powered by battery, such that the components may be completely wireless. The network may be entirely self-configuring such that the modules may be assembled and the network established in a straightforward manner.

The background description provided herein is for the purpose of generally presenting background context of the disclosure. Work of the presently named inventor, to the extent it is described in this background section, as well as aspects of the description that may not otherwise qualify as prior art at the time of filing, are neither expressly nor impliedly admitted as prior art against the present disclosure.

### SUMMARY OF THE INVENTION

This section provides a simplified summary in order to provide a basic understanding of some aspects described herein. This summary is not an extensive overview and is not intended to identify “key” or “critical” elements of the present disclosure or to delineate the scope of the various aspects described herein. The purpose of this portion of the document is to present some concepts in a simplified form as a prelude to the more detailed description that is presented later.

A method of operating a conveying system having a plurality of steerable wheel movers mechanically independent with respect to one another and arranged in a plurality of rows can include directing a first command from a master controller of the conveying system to at least a first sub-controller of a plurality of sub-controllers of the conveying system. The first command can indicate a first sub-group of the plurality of steerable wheel movers that is less than all of the plurality of steerable wheel movers. The first command can indicate a first steer angle. The method can also include receiving, with at least the first sub-controller, the first command from the master controller after the directing. The method can also include controlling at least one steerable wheel of the first sub-group of the plurality of steerable wheel movers, with the first sub-controller, to move to the first steer angle in response to the receiving the first command. The method can also include moving a first package travelling along the conveying system with the at least one of the first sub-group of the plurality of steerable wheel movers arranged at the first steer angle, in response to the controlling. The method can also include determining, with the master controller, after the directing the first command, during the moving, a second sub-group of the plurality of steerable wheel movers that is different than the first sub-group of the plurality of steerable wheel movers and is less than all of the steerable wheel movers. The method can also include directing a second command from the master controller to at least the first sub-controller. The second command can indicate the second sub-group of the plurality of steerable wheel movers. The second command can indicate a second steer angle. The method can also include receiving, with at least the first sub-controller, the second command from the master controller after the directing of the second command. The method can also include controlling at least one steerable wheel of the second sub-group of the plurality of steerable wheel movers, with at least the first sub-controller, to move to the second steer angle.

According to other features, the determining the second sub-group of the plurality of steerable wheel movers can be further defined as determining, with the master controller, after the directing the first command, during the moving, the second sub-group of the plurality of steerable wheel movers that is different than the first sub-group of the plurality of steerable wheel movers and is less than all of the steerable wheel movers and includes at least a first steerable wheel mover positioned in a first row of the plurality rows and a second steerable wheel mover positioned in a second row of the plurality rows that is different than the first row of the plurality rows.

In other features, the directing the second command can be further defined as directing the second command from the master controller to at least the first sub-controller and a second sub-controller of the plurality of sub-controllers, wherein the second command indicates the second sub-group of the plurality of steerable wheel movers and wherein the second command indicates a second steer angle. The receiving the second command can be further defined as receiving, with at least the first sub-controller and the second sub-controller, the second command from the master controller after the directing the second command. The controlling at least some of the second sub-group of the plurality of steerable wheel movers can be further defined as controlling the first steerable wheel mover with the first sub-controller and the second steerable wheel mover with the second sub-controller to both move to the second steer angle.

According to additional features, the determining the second sub-group of the plurality of steerable wheel movers can be further defined as determining, with the master controller, after the directing the first command, during the moving, the second sub-group of the plurality of steerable wheel movers that is different than the first sub-group of the plurality of steerable wheel movers and is less than all of the steerable wheel movers and includes at least a first steerable wheel mover from a first of the plurality rows and a second steerable wheel mover from a second of the plurality rows that is different than the first of the plurality rows and at least one of the first steerable wheel mover and the second steerable wheel mover was part of the first sub-group of the plurality of steerable wheel movers.

According to other features, the method can also include moving the first package with the second sub-group of the plurality of steerable wheel movers arranged at the second steer angle, after the moving the first package with the first sub-group of the plurality of steerable wheel movers, in response to the controlling the at least some of the second sub-group of the plurality of steerable wheel movers.

In other features, the determining the second sub-group of the plurality of steerable wheel movers can be further defined as determining, with the master controller, after the directing the first command, during the moving, the second sub-group of the plurality of steerable wheel movers that is different than the first sub-group of the plurality of steerable wheel movers and is less than all of the steerable wheel movers and includes at least a first steerable wheel mover positioned in a first row of the plurality rows and a second steerable wheel mover positioned in the first row of the plurality rows.

According to additional features, the controlling at least some of the second sub-group of the plurality of steerable wheel movers can be further defined as controlling both the first steerable wheel mover and the second steerable wheel mover with the first sub-controller to both move to the second steer angle. The determining the second sub-group of the plurality of steerable wheel movers can be further defined as determining, with the master controller, after the directing the first command, during the moving, the second sub-group of the plurality of steerable wheel movers that is different than the first sub-group of the plurality of steerable wheel movers and is less than all of the steerable wheel movers and includes the first steerable wheel mover and the second steerable wheel mover and at least one of the first steerable wheel mover and the second steerable wheel mover was part of the first sub-group of the plurality of steerable wheel movers.

According to other features, the determining the second sub-group of the plurality of steerable wheel movers can be further defined as determining, with the master controller, after the directing the first command, during the moving, the second sub-group of the plurality of steerable wheel movers that is different than the first sub-group of the plurality of steerable wheel movers and is less than all of the steerable wheel movers and includes the first steerable wheel mover and the second steerable wheel mover neither the first steerable wheel mover nor the second steerable wheel mover was part of the first sub-group of the plurality of steerable wheel movers.

In other features, the method can also include controlling at least a first steerable wheel of a third sub-group of the plurality of steerable wheel movers, with the first sub-controller, to move to a third steer angle different than the second steer angle, wherein the controlling the at least one steerable wheel of the second sub-group and the controlling at least the first steerable wheel of the third sub-group are at least partially contemporaneous. The at least a first steerable wheel of the third sub-group and the at least one steerable wheel of the second sub-group can be in the same row of the plurality of rows.

According to additional features, the method can also include controlling at least a first steerable wheel of a fourth sub-group of the plurality of steerable wheel movers, with the first sub-controller, to move to a fourth steer angle different than the third steer angle and the second steer angle, wherein the controlling the at least one steerable wheel of the second sub-group and the controlling the at least a first steerable wheel of the third sub-group and the controlling the at least a first steerable wheel of the fourth sub-group are at least partially contemporaneous.

According to other features, the controlling the at least one steerable wheel of the second sub-group can be further defined as controlling the at least one steerable wheel of the second sub-group of the plurality of steerable wheel movers, with at least the first sub-controller, to move to the second steer angle and to rotate at a first speed. The controlling at least a first steerable wheel of the third sub-group can be further defined as controlling at least the first steerable wheel of the third sub-group of the plurality of steerable wheel movers, with the first sub-controller, to move to the third steer angle different than the second steer angle and to rotate at a second speed different than the first speed, wherein the at least a first steerable wheel of the third sub-group and the at least one steerable wheel of the second sub-group are in the same row of the plurality of rows and wherein the controlling the at least one steerable wheel of the second sub-group and the controlling the at least the first steerable wheel of the third sub-group are at least partially contemporaneous.

In other features, at least one of the directing the first command and the receiving the first command can be further defined as executed over a network and the controlling the at least one steerable wheel of the first sub-group is not executed over the network. At least one of the directing the second command and the receiving the second command can be further defined as executed over the network and the controlling the at least one steerable wheel of the second sub-group is not executed over the network.

A conveying system can include a plurality of steerable wheel movers, a plurality of sub-controllers, and a master controller. The plurality of steerable wheel movers can be mechanically independent with respect to one another and can be arranged in a plurality of rows. Each of the plurality of sub-controllers can be disposed in communication with more than one of the plurality of steerable wheel movers. The master controller can be disposed in communication with all of the plurality of sub-controllers. The master controller can be configured to direct commands to the plurality of sub-controllers, including directing a first command to at least a first sub-controller of a plurality of sub-controllers of the conveying system, wherein the first command can indicate a first sub-group of the plurality of steerable wheel movers that is less than all of the plurality of steerable wheel movers and wherein the first command indicates a first steer angle. Each of the plurality of sub-controllers can be configured to receive commands from the master controller including receiving, with at least the first sub-controller, the first command from the master controller after the directing. Each of the plurality of sub-controllers can be configured to control the respective operations of at least some of the plurality of steerable wheel movers, including controlling at least one steerable wheel of the first sub-group of the plurality of steerable wheel movers to move to the first steer angle in response to the receiving the first command. Each of the plurality of steerable wheel movers can be configured to move packages along the conveying system, including moving a first package travelling along the conveying system with the at least one of the first sub-group of the plurality of steerable wheel movers arranged at the first steer angle, in response to the controlling. The master controller can be configured to determine, after directing the first command, during the moving of the first package, a second sub-group of the plurality of steerable wheel movers that is different than the first sub-group of the plurality of steerable wheel movers and is less than all of the steerable wheel movers. The master controller can be configured to direct a second command to at least the first sub-controller, wherein the second command indicates the second sub-group of the plurality of steerable wheel movers and wherein the second command indicates a second steer angle. The first sub-controller can be configured to receive the second command from the master controller. The first sub-controller can be configured to control at least one steerable wheel of the second sub-group of the plurality of steerable wheel movers, to move to the second steer angle.

According to other features, each of the plurality of sub-controllers can be further defined as disposed in communication with all of the plurality of steerable wheel movers that are positioned in a same row of the plurality of rows. The master controller may not be disposed to communicate commands to the plurality of steerable wheel movers.

In other features, the conveying system can also include a network, wherein the master controller can be disposed in communication with each of the plurality of sub-controllers over the network. The master controller can be configured to determine the second sub-group of the plurality of steerable wheel movers to include steerable wheel movers in different rows of the plurality of rows, to include only steerable wheel movers in the same row of the plurality of rows, or to include one or more of steerable wheel movers that had been included in the first sub-group of the plurality of steerable wheel movers

### BRIEF DESCRIPTION OF THE DRAWINGS

The detailed description set forth below references the following drawings:

FIG. 1 is a top schematic view of a conveying system according to a first exemplary embodiment of the present disclosure;

FIG. 2 is a top schematic view of a conveying system according to a second exemplary embodiment of the present disclosure; and

FIG. 3 is a schematic view of a portion of the first exemplary conveying system shown in FIG. 1.

### DETAILED DESCRIPTION

A plurality of different embodiments of the present disclosure is shown in the Figures of the application. Similar features are shown in the various embodiments of the present disclosure. Similar features across different embodiments have been numbered with a common reference numeral and have been differentiated by an alphabetic suffix. Similar features in a particular embodiment have been numbered with a common two-digit, base reference numeral and have been differentiated by a different leading numeral. Also, to enhance consistency, the structures in any particular drawing share the same alphabetic suffix even if a particular feature is shown in less than all embodiments. Similar features are structured similarly, operate similarly, and/or have the same function unless otherwise indicated by the drawings or this specification. Furthermore, particular features of one embodiment can replace corresponding features in another embodiment or can supplement other embodiments unless otherwise indicated by the drawings or this specification.

The present disclosure, as demonstrated by the exemplary embodiments described below, can provide a steerable wheel mover software linkage, in contrast to a mechanical linkage. One or more embodiments of the present disclosure provide a steer-by-wire algorithm and associated motors and controllers that can provide the same functionality of a steerable wheel system interconnection by mechanical linkages. But the exemplary linkages herein are software defined and able to change during operation while not requiring high bandwidth and large networks. Based on firmware loaded into a master controller, two or more wheels can steer together based on a single network message. This permits on-the-fly changes to the linkages among the steerable wheel movers. This provides a main system network communication bandwidth that is only as complex as necessary for the specific use case. When all of the steerable wheel movers in a particular row are controlled to steer together, the main system controller is only sending one message per row of steerable wheel movers. At the same time, embodiments of the present disclosure can achieve the ultimate flexibility provided by re-addressing steerable wheel movers to different sub-groups, including sub-groups, by way of example and not limitation, that include steerable wheel movers in different rows and/or less than all of the steerable wheel movers in a particular row.

Again referring to the simplest form, a sub-group could consist of all movers in one row defined in a perpendicular direction to the conveyor transport direction. In this manner, each row of the steerable wheel modules could have one address and one sub-controller enabling a relatively low cost, low speed network and master system controller. In such an embodiment, each row of movers could steer independently and permit a drastic shrinking of the required space between packages while maintaining a relatively easy control methodology. Furthermore, in contrast to prior systems wherein a dedicated steering motor exists for each row of movers, the present disclosure has an advantage of up time in the event of a failed motor. In most cases, if a single steering motor inside of a mover were to fail, the system operation would not be impacted and a replacement could be scheduled during planned maintenance cycles. Furthermore, the single mover can be understood as a building block such that systems of many different sizes can be built instead of being based on a fixed dimension. This permits rapid customization as well as low-cost upgrades after commissioning. However, when one steering motor is controlling multiple movers such as in prior systems, a failed steering motor can bring down the entire warehouse leading to costly downtime, such a motor cannot be easily upgraded, and it can be more difficult to customize the system.

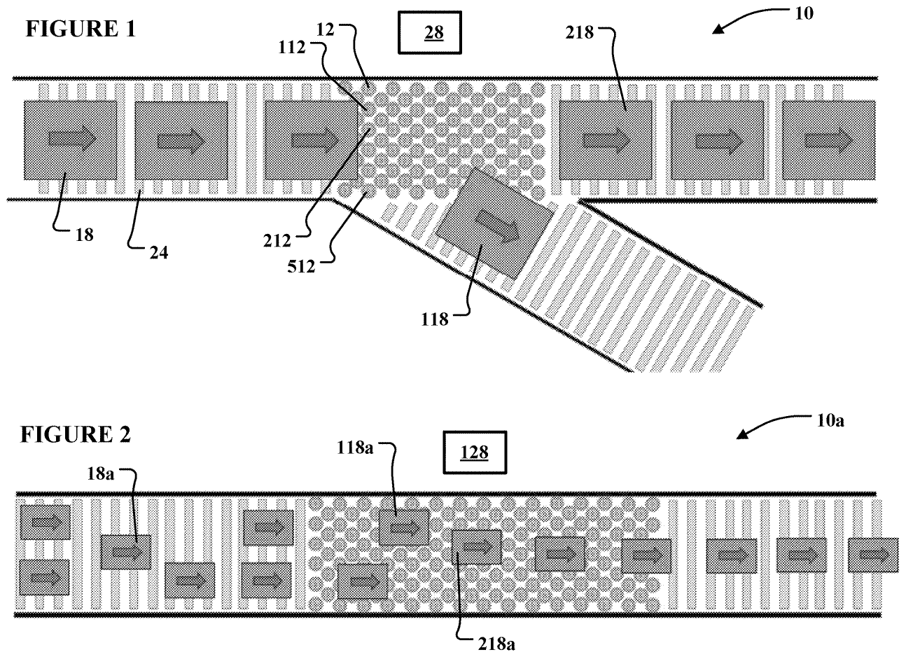

Generally, steerable wheel movers are used in warehouse automation as part of conveyor or conveying systems. The conveying systems can be used to transport boxes, packages, etc., along a transport path. When a package reaches a conveying system section including steerable wheel movers, the movers can steer the package to one of multiple different directions, including going straight or passing off the main conveyor onto another conveyor of some sort headed to either the left or right, at infinitely variable angles. This is considered a divert action and such a section is at least sometimes referred to as a “divert section” or a “diverter.” FIG. 1 is a top schematic view of an exemplary divert section. A second use case for steerable wheel movers is called a “singulator” or “singulator section.” In some operating environments, packages may be coming down a conveyor with two or three or more packages side-by-side. The singulator section rearranges the packages to be in a single-file line. FIG. 2 is a top schematic view of an exemplary singulator section.

The present disclosure provides a conveying system having a plurality of steerable wheel movers mechanically independent with respect to one another and arranged in a plurality of rows and a method of operating the conveying system. FIG. 1 is a top schematic view of a first exemplary embodiment of a conveying system 10 according to the present disclosure; the first exemplary embodiment being in the form a divert section. FIG. 2 is a top schematic view of a second exemplary embodiment of a conveying system 10a according to the present disclosure; the second exemplary embodiment being in the form a singulator section. The method disclosed herein can be executed by both exemplary conveying systems 10, 10a.

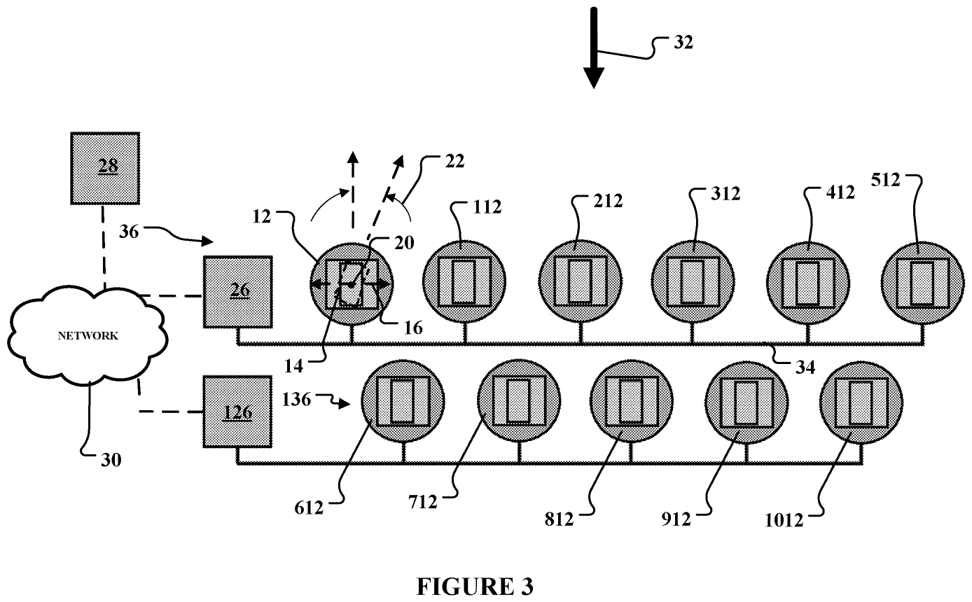

Referring now to FIG. 1, the exemplary conveying system 10 includes a plurality of steerable wheel movers such as exemplary steerable wheel movers 12, 112, 212 . . . 512. The exemplary plurality of steerable wheel movers of the conveying system 10 are arranged in a plurality of rows and the exemplary steerable wheel movers 12, 112, 212 . . . 512 are disposed in the same row, referenced by 36, of the exemplary plurality of rows. It is noted that other, similarly appearing but unnumbered structures shown in FIGS. 1 and 2 are also exemplary steerable wheel movers. FIG. 3 shows the exemplary steerable wheel movers 12, 112, 212 . . . 512 are disposed in the same row with exemplary steerable wheel movers 312 and 412. In one or more embodiments of the present disclosure, a row can be transverse (including but not limited to perpendicular) to a path of movement defined by the conveying system, but this disclosure is not limited to transverse rows. In one or more embodiments of the present disclosure, a row can be linear such as the row defined by the exemplary steerable wheel movers 12, 112, 212, 312, 412, 512, but this disclosure is not limited to linear rows.

Each of the exemplary steerable wheel movers can include a wheel or roller which will contact a package and rotate about a wheel axis of rotation. The exemplary steerable wheel mover 12 will be described in greater detail and is applicable to the other exemplary steerable wheel movers which are configured similarly. Referring now to FIG. 3, the wheel of the exemplary steerable wheel mover 12 is shown as a solid rectangle and is referenced by 14. The wheel axis of rotation of the exemplary wheel 14, when the exemplary wheel 14 is in the position shown in FIG. 3, is referenced by 16. Rotation of the wheel 14 about the axis 16 will move a package contacting the wheel 14. It is noted that packages are referenced in FIG. 1 at 18, 118, and 218 and are referenced in FIG. 2 at 18a, 118a, and 218a. It is noted that other, similarly appearing but unnumbered structures shown in FIGS. 1 and 2 are also exemplary packages.

Each of the exemplary steerable wheel movers can also rotate about a steer angle axis that is perpendicular to the wheel axis of rotation. The exemplary wheel axis of rotation 16 extends across the page of FIG. 3 and the exemplary steer angle axis is coming out of and into the page of FIG. 3 and is referenced at 20. In FIG. 3, the exemplary wheel 14 is shown in solid line while at a first steer angle designated, for exemplary purposes, as a “zero” steer angle. The exemplary wheel 14 is shown in dash line after being rotated about the exemplary steer angle axis 20 to a second steer angle, referenced by 22.

It is noted that steerable wheel movers that can be utilized in one or more embodiments of the present disclosure can take various forms. For example, exemplary steerable wheel movers can have a bidirectional roller wheel enabled to spin by a roller motor, such that when acting in contact with a package on a conveying system can propel the package in the direction of the roller. This form of steerable wheel mover can also have a steering mechanism to change the steer angle, enabled by a dedicated steering motor, acting to steer the direction of the roller from 0 to 180 degrees based on the intended direction that the package is controlled. Alternatively, exemplary steerable wheel movers can have a roller that is unidirectional and have the steering mechanism that can act over a range of 0 to 360 degrees.

It is noted that a steerable wheel mover is generally referred to as a diverter unit 11a, 11b in U.S. Pat. No. 7,040,478 and as a pitch independent transmission 50 in U.S. Pat. No. 9,745,143. However, the diverter units 11a and 11b disclosed in U.S. Pat. No. 7,040,478 and pitch independent transmission 50 in U.S. Pat. No. 9,745,143 are mechanically interconnect whereby the diverter units/pitch independent transmissions are moved to a common steer angle at the same time. In contrast, in the present disclosure, the steerable wheel movers are mechanically independent with respect to one another. Mechanically independent refers to each steerable wheel mover being moveable to a different steer angle without such movement being mechanically transferred to or mechanically transferred from another steerable wheel mover.

As shown in FIGS. 1 and 2, an embodiment of a conveying system according to the present disclosure may include sections without steerable wheel movers. Such sections may include non-steerable, wide rollers such as referenced at 24 in FIG. 1 and/or belt sections.

The exemplary conveying system 10 also includes a plurality of sub-controllers 26, 126. Referring now to FIG. 3, an exemplary first sub-controller is referenced at 26 and an exemplary second sub-controller is referenced at 126. Each of the plurality of exemplary sub-controllers is disposed in communication with more than one of said plurality of steerable wheel movers. Referring now to FIG. 3, the exemplary sub-controller 26 is disposed in communication with the exemplary steerable wheel movers 12, 112, 212, 312, 412, 512 and the exemplary sub-controller 126 is disposed in communication with the exemplary steerable wheel movers 612, 712, 812, 912, 1012. The exemplary steerable wheel movers 612, 712, 812, 912, 1012 are arranged in a row 136. Each of the plurality of sub-controllers 26, 126 is thus disposed in communication with all of the plurality of steerable wheel movers that are positioned in the same row of the plurality of rows. In one or more embodiments of the present disclosure, a Texas Instruments F2800137PT can be utilized as a sub-controller.

The exemplary conveying system 10 also includes a master controller that is disposed in communication with all of the plurality of sub-controllers. The master controller is referenced at 28 in FIGS. 1 and 3 and at 128 in FIG. 2. In one or more embodiments of the present disclosure, a Texas Instruments F2800137PT can be utilized as a master controller.

Referring again to FIG. 3, the exemplary master controller 28 is disposed in communication with each of the exemplary sub-controllers 26, 126 over a network 30. It is noted that networks are present in the embodiments shown in FIGS. 1 and 2 despite not being shown or referenced. The exemplary network 30, illustrated schematically, can include a local area network (LAN), a wide area network (WAN), e.g., the Internet, a Multi-protocol label switching (MPLS) network, a cellular network such as operated by cellular phone companies, or any combination thereof. The exemplary network 30 can be practiced with a wireless network, a hard-wired network, or any combination thereof. The present disclosure is well suited to a wide variety of computer network systems over numerous topologies.

In the exemplary embodiment of the present disclosure, the master controller 28 is not configured or disposed to communicate commands to the steerable wheel movers 12-1012. Commands can be transmitted to the sub-controllers and the sub-controllers communicate commands to the steerable wheel movers. The exemplary master system controller 28 can “steer” all of the motors that respectively control the steer angle of all of the steerable wheel movers of a sub-group at once by using one message/command on the network 30.

In an exemplary method of operating the exemplary conveying system 10, the master controller 28 can direct a first command to at least the first sub-controller 26. The first command can be directed or transmitted or sent over the network 30. The first command indicates a first sub-group of the plurality of steerable wheel movers. The first sub-group of the plurality of steerable wheel movers is less than all of the plurality of steerable wheel movers. For example, with reference to FIG. 3, a package is moving in a direction referenced by arrow 32 and the exemplary first sub-group of steerable wheel movers can include movers 12, 112 and 212, which is less than all of the plurality of steerable wheel movers. It is noted that FIG. 3 only shows two rows of the steerable wheel movers of the exemplary conveying system 10 shown in FIG. 1. Thus, in this example, the first command indicates/identifies the movers 12, 112 and 212. The first command also indicates a first steer angle. In this example, the first steer angle can be the angle 22. Thus, in this example, the first command indicates/identifies the angle 22. The first command can also indicate a speed of rotation about the wheel axis of rotation. The speed of rotation about the wheel axis of rotation may be the same for all movers of the sub-group. Alternatively, one or more of the movers in a sub-group may be controlled to move at different speeds. Further, movers in a single row may be controlled at different speeds.

Since the exemplary movers 12, 112 and 212 are all under the control of the exemplary sub-controller 26, the master controller 28 can direct the first command to a single address in the network, the address of the exemplary sub-controller 26. Generally, the master controller 28 can direct a command to all of the sub-controllers that communicate with any of the steerable wheel movers that are part of the immediate sub-group of movers. If the immediate sub-group includes movers in multiple rows, the master controller 28 can direct a command to multiple sub-controllers. It is noted that in some operating circumstances, a single sub-controller may be communicating with movers in multiple sub-groups and thus receive multiple commands substantially concurrently.

After the first command is sent by the master controller 28, in this example, it can be received by the exemplary first sub-controller 26. It is noted that the present disclosure contemplates the first sub-controller 26 receiving the first command directly or indirectly from the master controller 28. After receiving the first command and in response thereto, the exemplary first sub-controller 26 can control the exemplary movers 12, 112 and 212 to move to the steer angle 22. It is noted that in various operating scenarios, the first sub-controller 26 can control more than one of exemplary movers 12, 112, 212 to move in response to the command emitted by the master controller 28; a software linkage is thus defined between movers rather than a mechanical linkage. This is shown by further examples set forth herein. The exemplary first sub-controller 26 can send a control signal over a bus 34 that is distinct from the network 30 and each of the exemplary movers 12, 112 and 212 is connected to the bus 34. After receiving the control/command from the exemplary sub-controller 26 and in response thereto, the exemplary movers 12, 112, 212 move to the directed steer angle and rotate at the directed wheel speed and moving the package travelling along the exemplary conveying system 10.

After directing the first command, the master controller 28 can dynamically determine subsequent, successive sub-groups of steerable wheel movers to further effect the movement of packages along the exemplary conveying system 10. Like the first sub-group, the exemplary master controller 28 can determine second, third, fourth, etc., sub-groups of steerable wheel movers that are each different than immediately preceding sub-groups and each of these sub-groups can be defined by less than all of the steerable wheel movers of exemplary conveying system 10.

The exemplary conveying system 10 can include a plurality of sensors that, during operation, generate signals about the speed of movement and the size of packages positioned on the steerable wheel movers or upstream of the steerable wheel movers. In addition, the steerable wheel movers can transmit operating data such as motor current, position error (difference between commanded position and actual position), velocity error (difference between commanded velocity and actual velocity), motor power consumption, and motor temperature rise that indicates the locations of packages. In addition, data about the identity of each package, such as its delivery location, can be transmitted to the exemplary conveying system 10.

This data can be received and processed by the exemplary master controller 28 to determine the location of each package supported by the exemplary conveying system 10, in order to determine the identities of the steerable wheel movers to include in a sub-group that will next move that package. In one or more other embodiments of the present disclosure, the data can be received and processed by another computing device which determines the location of each package supported by the exemplary conveying system 10 to reduce the processing burden on the master controller 28. These locations can be communicated to the exemplary master controller 28, whereby the exemplary master controller 28 can then determine the identities of the steerable wheel movers to include in a sub-group that will next move that package.

The exemplary master controller 28 is configured to determine the identities of the steerable wheel movers in the second sub-group based on the sizes and locations of packages moving along the exemplary conveying system 10. Because the steerable wheel movers are mechanically independent, the exemplary master controller 28 can select any combination of steerable wheel movers to most effectively continue movements of the packages along the exemplary conveying system 10. A sub-group can be defined by steerable wheel movers in different rows of the plurality of rows. A sub-group can include only steerable wheel movers in the same row of the plurality of rows. A sub-group can include, in a second sub-group, one or more of the steerable wheel movers that had been included in a prior, first sub-group of steerable wheel movers.

In one example, the exemplary master controller 28 can determine a second sub-group that is successive or subsequent to the first sub-group and includes steerable wheel movers in different rows. For example, referring to FIG. 3, the exemplary master controller 28 can determine the first sub-group to include the exemplary steerable wheel movers 12 and 112 and direct the first command to the exemplary sub-controller 26. Next, as a package is being moved by the exemplary steerable wheel movers 12 and 112, the exemplary master controller 28 can determine the second sub-group to include the exemplary steerable wheel movers 12, 112, 612, and 712. Thus, in this example, the second sub-group of the plurality of steerable wheel movers is different than the first sub-group of the plurality of steerable wheel movers, is less than all of the steerable wheel movers of the exemplary conveying system 10, and includes at least one first steerable wheel mover positioned in a first row 36 of the plurality rows and a second steerable wheel mover positioned in a second row 136 of the plurality rows that is different than the first row 36 of the plurality rows. The exemplary master controller 28 could then direct the second command to both sub-controllers 26, 126. The second command would then be received by the exemplary first sub-controller 26 and the exemplary second sub-controller 126. The exemplary first sub-controller 26 would then control the steerable wheel movers 12, 112 to move to the second steer angle and the exemplary second sub-controller 126 would then control the steerable wheel movers 612, 712 to move to the second steer angle. This example also demonstrates the determination of a subsequent, second sub-group that includes at least one steerable wheel mover that was part of a prior, first sub-group of steerable wheel movers.

So, in the example above, a first package can be moved first by the exemplary steerable wheel movers 12, 112, with the exemplary steerable wheel movers 12, 112. After sending the first command to effectuate this movement, the exemplary master controller 28 can determine the exemplary steerable wheel movers 12, 112, 612, 712 as the sub-group steerable wheel movers that will next move this first package and send the second command so that exemplary steerable wheel movers 12, 112, 612, 712 are all at the desired steer angle. It is noted that in response to some operating conditions the first steer angle and the second steer angle may be the same.

In another example, the exemplary master controller 28 can determine a second sub-group that is successive or subsequent to the first sub-group and includes steerable wheel movers in the same row. For example, referring to FIG. 3, the exemplary master controller 28 can determine the first sub-group to include the exemplary steerable wheel movers 12 and 112 and direct the first command to the exemplary sub-controller 26. Next, as another package is being moved toward the row 36, the exemplary master controller 28 can determine the second sub-group to include the exemplary steerable wheel movers 312, 412, and 512. Thus, in this example, the second sub-group of the plurality of steerable wheel movers is different than the first sub-group of the plurality of steerable wheel movers, is less than all of the steerable wheel movers of the exemplary conveying system 10, and includes steerable wheel movers positioned in the same row as the first sub-group. The exemplary master controller 28 could then direct the second command to the exemplary sub-controller 26. The exemplary first sub-controller 26 would then control the steerable wheel movers 312, 412, 512 to move to the second steer angle. This example also demonstrates the determination of a second sub-group that includes none of the steerable wheel movers that were part of a prior, first sub-group of steerable wheel movers. It is noted that in response to some operating conditions, such as when two packages are moving side-by-side to the row 36, the first and second commands can both be sent to the exemplary sub-controller 26 at the same time (or substantially at the same time, as processing and hardware capabilities permit).

In another example, the exemplary master controller 28 can determine a second sub-group that is successive or subsequent to the first sub-group, includes steerable wheel movers in the same row, and also includes steerable wheel movers that had been in the first sub-group. For example, referring to FIG. 3, the exemplary master controller 28 can determine the first sub-group to include the exemplary steerable wheel movers 12 and 112 and direct the first command to the exemplary sub-controller 26. Next, as another package is being moved toward the row 36, the exemplary master controller 28 can determine the second sub-group to include the exemplary steerable wheel movers 112, 212, and 312. Thus, in this example, the second sub-group of the plurality of steerable wheel movers is different than the first sub-group of the plurality of steerable wheel movers, is less than all of the steerable wheel movers of the exemplary conveying system 10, includes steerable wheel movers positioned in the same row as the first sub-group, and involves the “switch” of the exemplary steerable wheel movers 112 from the first sub-group to the second sub-group. The exemplary master controller 28 could then direct the second command to the exemplary sub-controller 26. The exemplary first sub-controller 26 would then control the steerable wheel movers 112, 212, 312 to move to the second steer angle.

In another example, the exemplary master controller 28 can determine a second sub-group and further sub-groups that are fully or partially contemporaneous with the first sub-group. For example, referring to FIG. 3, the exemplary master controller 28 can determine a first sub-group to include the exemplary steerable wheel movers 12 and 112, a second sub-group to include the exemplary steerable wheel movers 212 and 312, and a third sub-group to include the exemplary steerable wheel movers 412 and 512. Multiple sub-groups defined on a single row can be desirable to address multiple packages on or approaching a single row at the same time. The exemplary master controller 28 can direct a first command for the first sub-group, a second command for the second sub-group, and a third command for the third sub-group to the exemplary sub-controller 26. Each of the first command, the second command, and the third command may indicate a different steer angle. The exemplary master controller 28 can send the commands to the exemplary sub-controller 26 at the same time (or substantially at the same time, as processing and hardware capabilities permit). Thus, each of the first, second and third sub-groups can be separately addressable and responded to by the exemplary sub-controller 26. Each sub-controller can thus respond to one or more than one address on the network 30.

In another example, the exemplary master controller 28 can determine that all of the movers in a particular row define in whole or in part a particular sub-group.

It is noted that the examples disclosed above can also occur in the embodiment of the disclosure shown in FIG. 2.

What has been described above includes examples of the subject innovation. It is, of course, not possible to describe every conceivable combination of components or methodologies for purposes of describing the disclosed subject matter, but many further combinations and permutations of the subject innovation are possible. The use of any and all examples, or exemplary language (e.g., “such as”) provided herein is intended merely to be illustrative and does not pose a limitation on the scope of any innovation disclosed herein unless otherwise claimed. The word “exemplary” is used to mean serving as an example, instance, or illustration. Any aspect or design described herein as “exemplary” is not necessarily to be construed as preferred or advantageous over other aspects or designs. Rather, use of the word “exemplary” is intended to present concepts in a concrete fashion. Further, any statements set forth within the Detailed Description of this document and addressing a prior art device(s) are the observations of the inventors and such statements themselves are not prior art or admissions as to what is prior art.

As used herein, the singular forms “a,” “an,” and “the” include plural referents unless the context clearly dictates otherwise. Unless indicated otherwise by context, the term “or” is to be understood as an inclusive “or.” Terms such as “first”, “second”, “third”, etc. when used to describe multiple devices or elements, are so used only to convey the relative actions, positioning and/or functions of the separate devices, and do not necessitate either a specific order for such devices or elements, or any specific quantity or ranking of such devices or elements. Use of the terms “about” or “approximately” are intended to cover values that are above and/or below a stated value or range, or within manufacturing tolerances, as would be understood by one having ordinary skill in the art in the respective context. In some instances, this may encompass values in a range of approx. +/−10%; in other instances there may be encompassed values in a range of approx. +/−5%; in yet other instances values in a range of approx. +/−2% may be encompassed; and in yet further instances, this may encompass values in a range of approx. +/−1%.

It will be understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof, unless indicated herein or otherwise clearly contradicted by context. Recitations of a value range herein, unless indicated otherwise, serves as a shorthand for referring individually to each separate value falling within the stated range, including the endpoints of the range, each separate value within the range, and all intermediate ranges subsumed by the overall range, with each incorporated into the specification as if individually recited herein. Unless indicated otherwise, or clearly contradicted by context, methods described herein can be performed with the individual steps executed in any suitable order, including: the precise order disclosed, without any intermediate steps or with one or more further steps interposed between the disclosed steps; with the disclosed steps performed in an order other than the exact order disclosed; with one or more steps performed simultaneously; and with one or more disclosed steps omitted, unless expressly contradicted by the text herein or context.

While the present disclosure has been described with reference to one or more exemplary embodiments, it is to be understood that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to a particular embodiment disclosed herein as the best mode contemplated for carrying out this present disclosure, but that the present disclosure will be viewed as covering any embodiment falling within the scope of the appended claims. Various aspects or features described herein may be implemented as a method, apparatus, or article of manufacture using standard programming and/or engineering techniques.

Also, the right to claim for patent coverage a particular sub-feature, a sub-component, or a sub-element of any disclosed embodiment, singularly or in one or more sub-combinations with any other sub-feature(s), sub-component(s), or sub-element(s), is hereby unconditionally reserved by the Applicant. Also, particular sub-feature(s), sub-component(s), and sub-element(s) of one embodiment that is disclosed herein can replace particular sub-features, sub-components, and sub-elements of another embodiment disclosed herein or can supplement and be added to another embodiment unless expressly indicated otherwise by the drawings or this specification. The inventor also assert that any of the claims set forth after this detailed description can be combined with any other claim or claims regardless of whether or not there is a direct line of dependency, unless there is an express indication in this text or the drawings unambiguously indicating that such a combination is not possible. The order of the claims and the lines of dependency are irrelevant to the various ways that the features, elements, sub-elements, components, sub-components, etc. of the present disclosure can be combined and thus claimed. Further, the doctrine of claim differentiation is to be applied in construing the appended claims. Further, the use of the word “can” in this document is not an assertion that the subject preceding the word “can” is unimportant or unnecessary or “not critical” relative to anything else in this document. The word “can” is used herein in a positive and affirming sense and no other motive should be presumed. More than one patentable “invention” may be disclosed in the present disclosure and it is noted that an “invention” is defined by the content of a patent claim and not by the content of descriptive text or drawings

1. A method of operating a conveying system having a plurality of steerable wheel movers mechanically independent with respect to one another and arranged in a plurality of rows comprising:
directing a first command from a master controller of the conveying system to at least a first sub-controller of a plurality of sub-controllers of the conveying system, wherein the first command indicates a first sub-group of the plurality of steerable wheel movers that is less than all of the plurality of steerable wheel movers and wherein the first command indicates a first steer angle;
receiving, with at least the first sub-controller, the first command from the master controller after said directing;
controlling at least one of the steerable wheels of the first sub-group of the plurality of steerable wheel movers, with the first sub-controller, to move to the first steer angle in response to said receiving the first command;
moving a first package travelling along the conveying system with the first sub-group of the plurality of steerable wheel movers all arranged at the first steer angle, in response to said controlling;
determining, with the master controller, after said directing the first command, during said moving, a second sub-group of the plurality of steerable wheel movers that is different than the first sub-group of the plurality of steerable wheel movers and is less than all of the steerable wheel movers;
directing a second command from the master controller to at least the first sub-controller, wherein the second command indicates the second sub-group of the plurality of steerable wheel movers and wherein the second command indicates a second steer angle;
receiving, with at least the first sub-controller, the second command from the master controller after said directing the second command; and
controlling at least one of the steerable wheels of the second sub-group of the plurality of steerable wheel movers, with at least the first sub-controller, to move to the second steer angle.

2. The method of claim 1 wherein:
said determining the second sub-group of the plurality of steerable wheel movers is further defined as determining, with the master controller, after said directing the first command, during said moving, the second sub-group of the plurality of steerable wheel movers that is different than the first sub-group of the plurality of steerable wheel movers and is less than all of the steerable wheel movers and includes at least a first steerable wheel mover positioned in a first row of the plurality rows and a second steerable wheel mover positioned in a second row of the plurality rows that is different than the first row of the plurality rows.

3. The method of claim 2 wherein:
said directing the second command is further defined as directing the second command from the master controller to the first sub-controller and to a second sub-controller of the plurality of sub-controllers, wherein the second command indicates the second sub-group of the plurality of steerable wheel movers and wherein the second command indicates the second steer angle;
said receiving the second command is further defined as receiving, with the first sub-controller and the second sub-controller, the second command from the master controller after said directing the second command; and
said controlling at least some of the second sub-group of the plurality of steerable wheel movers is further defined as controlling the first steerable wheel mover with the first sub-controller and the second steerable wheel mover with the second sub-controller to both move to the second steer angle.

4. The method of claim 3 wherein:
said determining the second sub-group of the plurality of steerable wheel movers is further defined as determining, with the master controller, after said directing the first command, during said moving, the second sub-group of the plurality of steerable wheel movers that is different than the first sub-group of the plurality of steerable wheel movers and is less than all of the steerable wheel movers and includes at least a first steerable wheel mover from a first of the plurality rows and a second steerable wheel mover from a second of the plurality rows that is different than the first of the plurality rows and at least one of the first steerable wheel mover and the second steerable wheel mover was part of the first sub-group of the plurality of steerable wheel movers.

5. The method of claim 4 further comprising:
moving the first package with the second sub-group of the plurality of steerable wheel movers arranged at the second steer angle, after said moving the first package with the first sub-group of the plurality of steerable wheel movers, in response to said controlling the at least some of the second sub-group of the plurality of steerable wheel movers.

6. The method of claim 1 wherein:
said determining the second sub-group of the plurality of steerable wheel movers is further defined as determining, with the master controller, after said directing the first command, during said moving, the second sub-group of the plurality of steerable wheel movers that is different than the first sub-group of the plurality of steerable wheel movers and is less than all of the steerable wheel movers and includes at least a first steerable wheel mover positioned in a first row of the plurality rows and a second steerable wheel mover positioned in the first row of the plurality rows.

7. The method of claim 6 wherein:
said controlling at least some of the second sub-group of the plurality of steerable wheel movers is further defined as controlling both the first steerable wheel mover and the second steerable wheel mover with the first sub-controller to both move to the second steer angle.

8. The method of claim 7 wherein:
said determining the second sub-group of the plurality of steerable wheel movers is further defined as determining, with the master controller, after said directing the first command, during said moving, the second sub-group of the plurality of steerable wheel movers that is different than the first sub-group of the plurality of steerable wheel movers and is less than all of the steerable wheel movers and includes the first steerable wheel mover and the second steerable wheel mover and at least one of the first steerable wheel mover and the second steerable wheel mover was part of the first sub-group of the plurality of steerable wheel movers.

9. The method of claim 7 wherein:
said determining the second sub-group of the plurality of steerable wheel movers is further defined as determining, with the master controller, after said directing the first command, during said moving, the second sub-group of the plurality of steerable wheel movers that is different than the first sub-group of the plurality of steerable wheel movers and is less than all of the steerable wheel movers and includes the first steerable wheel mover and the second steerable wheel mover neither the first steerable wheel mover nor the second steerable wheel mover was part of the first sub-group of the plurality of steerable wheel movers.

10. The method of claim 1 further comprising:
controlling at least a first steerable wheel of a third sub-group of the plurality of steerable wheel movers, with the first sub-controller, to move to a third steer angle different than the second steer angle, wherein said controlling the at least one steerable wheel of the second sub-group and said controlling at least the first steerable wheel of the third sub-group are at least partially contemporaneous.

11. The method of claim 10 wherein the at least a first steerable wheel of the third sub-group and the at least one steerable wheel of the second sub-group are in the same row of the plurality of rows.

12. The method of claim 10 further comprises:
controlling at least a first steerable wheel of a fourth sub-group of the plurality of steerable wheel movers, with the first sub-controller, to move to a fourth steer angle different than the third steer angle and the second steer angle, wherein said controlling the at least one steerable wheel of the second sub-group and said controlling the at least a first steerable wheel of the third sub-group and said controlling the at least a first steerable wheel of the fourth sub-group are at least partially contemporaneous.

13. The method of claim 10 wherein:
said controlling the at least one steerable wheel of the second sub-group is further defined as controlling the at least one steerable wheel of the second sub-group of the plurality of steerable wheel movers, with at least the first sub-controller, to move to the second steer angle and to rotate at a first speed; and
said controlling at least a first steerable wheel of the third sub-group is further defined as controlling at least the first steerable wheel of the third sub-group of the plurality of steerable wheel movers, with the first sub-controller, to move to the third steer angle different than the second steer angle and to rotate at a second speed different than the first speed, wherein the at least a first steerable wheel of the third sub-group and the at least one steerable wheel of the second sub-group are in the same row of the plurality of rows and wherein said controlling the at least one steerable wheel of the second sub-group and said controlling the at least the first steerable wheel of the third sub-group are at least partially contemporaneous.

14. The method of claim 1 wherein at least one of said directing the first command and said receiving the first command is further defined as executed over a network and said controlling the at least one steerable wheel of the first sub-group is not executed over the network.

15. The method of claim 14 wherein at least one of said directing the second command and said receiving the second command is further defined as executed over the network and said controlling the at least one steerable wheel of the second sub-group is not executed over the network.

16. A conveying system comprising:
a plurality of steerable wheel movers mechanically independent with respect to one another and arranged in a plurality of rows;
a plurality of sub-controllers, each disposed in communication with more than one of said plurality of steerable wheel movers; and
a master controller disposed in communication with all of the plurality of sub-controllers; and
wherein:
said master controller is configured to direct commands to said plurality of sub-controllers, including directing a first command to at least a first sub-controller of a plurality of sub-controllers of the conveying system, wherein the first command indicates a first sub-group of the plurality of steerable wheel movers that is less than all of the plurality of steerable wheel movers and wherein the first command indicates a first steer angle;
each of said plurality of sub-controllers is configured to receive commands from the master controller including receiving, with at least the first sub-controller, the first command from the master controller after said directing;
each of said plurality of sub-controllers is configured to control the respective operations of at least some of the plurality of steerable wheel movers, including controlling at least one steerable wheel of the first sub-group of the plurality of steerable wheel movers, with the first sub-controller, to move to the first steer angle in response to said receiving the first command;
each of the plurality of steerable wheel movers is configured to move packages along said conveying system, including moving a first package travelling along the conveying system with the at least one of the first sub-group of the plurality of steerable wheel movers arranged at the first steer angle, in response to said controlling;
said master controller is configured to determine, after directing the first command, during the moving of the first package, a second sub-group of the plurality of steerable wheel movers that is different than the first sub-group of the plurality of steerable wheel movers and is less than all of the steerable wheel movers;
said master controller is configured to direct a second command to at least the first sub-controller, wherein the second command indicates the second sub-group of the plurality of steerable wheel movers and wherein the second command indicates a second steer angle;
said first sub-controller is configured to receive the second command from said master controller; and
said first sub-controller is configured to control at least one steerable wheel of the second sub-group of the plurality of steerable wheel movers, to move to the second steer angle.

17. The conveying system of claim 16 wherein each of said plurality of sub-controllers is further defined as disposed in communication with all of said plurality of steerable wheel movers that are positioned in a same row of the plurality of rows.

18. The conveying system of claim 17 wherein said master controller is not disposed to communicate commands to said plurality of steerable wheel movers.

19. The conveying system of claim 18 further comprising:
a network, wherein said master controller is disposed in communication with each of said plurality of sub-controllers over the network.

20. The conveying system of claim 19 wherein said master controller is configured to determine the second sub-group of the plurality of steerable wheel movers to selectively include steerable wheel movers in different rows of the plurality of rows, to include only steerable wheel movers in the same row of the plurality of rows, and to include one or more of steerable wheel movers that had been included in the first sub-group of the plurality of steerable wheel movers.
